(19) United States
(12) Patent Application Publication
(10) Pub. No.: US 2026/0269166 A1
(43) Pub. Date: Sep. 10, 2026

(54) SURFACE TREATMENT METHOD, STAINLESS STEEL COMPONENT, X-RAY TUBE, X-RAY TUBE DEVICE, MANUFACTURING METHOD OF STAINLESS STEEL COMPONENT, AND MANUFACTURING METHOD OF X-RAY TUBE

(71) Applicant: FUJIFILM Corporation, Tokyo (JP)

(72) Inventor: Yoshitaka SEKI, Tokyo (JP)

(73) Assignee: FUJIFILM Corporation, Tokyo (JP)

(21) Appl. No.: 19/557,170

(22) Filed: Mar. 5, 2026

(30) Foreign Application Priority Data
Mar. 7, 2025 (JP) 2025-036768

(51) Int. Cl. H01J 35/10; C23C 8/02; C23C 8/18

(52) U.S. Cl. CPC H01J 35/105; C23C 8/02; C23C 8/18; H01J 2235/1204

(57) ABSTRACT

This disclosure describes a surface treatment method for producing a film with a high radiation rate that can be used in a vacuum, offering low cost and minimal environmental burden. A surface treatment method according to the present disclosure includes a sandblasting treatment step of performing a sandblasting treatment on a surface of stainless steel, and a greening treatment step of performing a greening treatment on the surface after the sandblasting treatment step, in which a surface roughness Ra of the surface after the greening treatment step is 0.70 μm or more and 1.00 μm or less. A stainless steel component according to the present disclosure is a stainless steel component in which a greening treatment is performed on a surface after a sandblasting treatment step, in which a surface roughness Ra of the surface after the greening treatment step is 0.70 μm or more and 1.00 μm or less.

### CROSS-REFERENCE TO RELATED APPLICATION

The present application claims priority under 35 U.S.C §119(a) to Japanese Patent Application No. 2025-036768 filed on Mar. 7, 2025, which is hereby expressly incorporated by reference, in its entirety, into the present application.

### BACKGROUND

### 1. Field

The present disclosure relates to a surface treatment method, a stainless steel component, an X-ray tube, an X-ray tube device, a manufacturing method of a stainless steel component, and a manufacturing method of an X-ray tube, and particularly to a surface treatment technology for obtaining a film having a particularly high radiation rate.

### 2. Description of the Related Art

An X-ray computed tomography (CT) apparatus includes an X-ray tube device that irradiates a subject with X-rays. The X-ray tube device includes an X-ray tube that generates X-rays by causing an electron beam to collide with a target of an anode. A rotating anode type X-ray tube that rotates the target of the anode is used in the X-ray CT apparatus. The rotating anode type X-ray tube includes a housing that maintains an inside of the housing at a high vacuum, and an anode that includes a target and a rotor connected to the target is held inside the housing.

The temperature of the target increases to about 1000° C. due to the generation of X-rays. The majority of the generated heat is dissipated to the housing by radiation from a surface of the target.

JP1993-62622A (JP-H5-62622A) discloses a rotating anode X-ray tube having a structure in which a radiation heat transfer amount from the target of the anode to the rotor is minimized.

### SUMMARY

In a case where the temperature of the target cannot be maintained lower than a melting point of the target, there is a problem that the target is melted. Therefore, in order to efficiently dissipate heat of the anode, it has been a problem to obtain a film having a high radiation rate.

The present disclosure has been made in view of such circumstances, and an object of the present disclosure is to provide a surface treatment method, a stainless steel component, an X-ray tube, an X-ray tube device, a manufacturing method of a stainless steel component, and a manufacturing method of an X-ray tube, in which a film having a high radiation rate that can be used in a vacuum, that is low in cost, and that has a small environmental burden can be obtained.

In order to achieve the above object, a surface treatment method according to a first aspect of the present disclosure comprises a sandblasting treatment step of performing a sandblasting treatment on a surface of stainless steel, and a greening treatment step of performing a greening treatment on the surface after the sandblasting treatment step, in which a surface roughness Ra of the surface after the greening treatment step is 0.70 μm or more and 1.00 μm or less.

In the surface treatment method according to a second aspect of the present disclosure, in the surface treatment method according to the first aspect, it is preferable that a surface roughness Ra of the surface after the greening treatment step is 0.75 μm or more and 0.90 μm or less.

In the surface treatment method according to a third aspect of the present disclosure, in the surface treatment method according to the first aspect, it is preferable that a surface roughness Ra of the surface after the greening treatment step is 0.78 μm or more and 0.85 μm or less.

In the surface treatment method according to a fourth aspect of the present disclosure, in the surface treatment method according to any one of the first to third aspects, it is preferable that the sandblasting treatment includes blasting with an abrasive having a particle size of F150 or F180 defined in JIS R6001.

In the surface treatment method according to a fifth aspect of the present disclosure, in the surface treatment method according to any one of the first to fourth aspects, the greening treatment includes holding the surface in a wet hydrogen atmosphere at 1000° C. or higher for 10 minutes or longer.

In the surface treatment method according to a sixth aspect of the present disclosure, in the surface treatment method according to any one of the first to fifth aspects, it is preferable that the stainless steel is martensitic stainless steel.

In order to achieve the above object, a stainless steel component according to a seventh aspect of the present disclosure is a stainless steel component in which a greening treatment is performed on a surface after a sandblasting treatment, in which a surface roughness Ra of the surface after the greening treatment is 0.70 μm or more and 1.00 μm or less.

In order to achieve the above object, an X-ray tube according to an eighth aspect of the present disclosure comprises a cathode that generates an electron beam, an anode that emits X-rays by collision of the electron beam, a housing that insulatingly supports the cathode and the anode in a vacuum atmosphere, a rotor that supports the anode, and the stainless steel component according to the seventh aspect.

In order to achieve the above object, an X-ray tube device according to a ninth aspect of the present disclosure comprises the X-ray tube according to the eighth aspect, and a container that accommodates the X-ray tube together with insulating oil.

In order to achieve the above object, a manufacturing method of a stainless steel component according to a tenth aspect of the present disclosure comprises a sandblasting treatment step of performing a sandblasting treatment on a surface of the stainless steel component, and a greening treatment step of performing a greening treatment on the surface after the sandblasting treatment step, in which a surface roughness Ra of the surface after the greening treatment step is 0.70 μm or more and 1.00 μm or less.

In order to achieve the above object, an eleventh aspect of the present disclosure relates to a manufacturing method of an X-ray tube including a cathode that generates an electron beam, an anode that emits X-rays by collision of the electron beam, a housing that insulatingly supports the cathode and the anode in a vacuum atmosphere, and a rotor that supports the anode, the manufacturing method comprising: a sandblasting treatment step of performing a sandblasting treatment on a surface of a part of at least one of the rotor or the housing; and a greening treatment step of performing a greening treatment on the surface after the sandblasting treatment step, in which a surface roughness Ra of the surface after the greening treatment step is 0.70 μm or more and 1.00 μm or less.

According to the present disclosure, a film having a high radiation rate that can be used in a vacuum, that is low in cost, and that has a small environmental burden can be obtained.

### BRIEF DESCRIPTION OF THE DRAWINGS

FIG. 1 is a schematic configuration diagram of an X-ray tube device according to an embodiment.

FIG. 2 is a schematic configuration diagram of an X-ray tube.

FIG. 3 is a table showing measurement results of a surface roughness Ra and a radiation rate ε of Tests 1 to 24.

FIG. 4 is a graph in which measurement results of Tests 1 to 22 are plotted with the surface roughness Ra as an abscissa and the radiation rate ε as an ordinate.

FIG. 5 is a photograph of a surface of a black body tape.

FIG. 6 is a photograph of a surface of Tests 23 and 24.

FIG. 7 is a photograph of a surface of Tests 3 and 8.

FIG. 8 is a photograph of a surface of Tests 5 and 10.

FIG. 9 is a photograph of a surface of Tests 12 and 18.

FIG. 10 is a photograph of a surface of Tests 16 and 22.

FIG. 11 is a roughness curve of a surface of Tests 23 and 24.

FIG. 12 is a roughness curve of a surface of Tests 3, 8, 5, and 10.

FIG. 13 is a roughness curve of a surface of Tests 12, 18, 16, and 22.

FIG. 14 is a diagram for describing an effect of a greening treatment.

FIG. 15 is a diagram for describing a comparison between a sandpaper treatment and a sandblasting treatment.

FIG. 16 is a diagram for describing an optimal value of the surface roughness Ra.

### DESCRIPTION OF THE PREFERRED EMBODIMENTS

Hereinafter, preferred embodiments of the present disclosure will be described in detail with reference to the accompanying drawings. In the present specification, the same components are denoted by the same reference numerals, and duplicate description thereof will be omitted as appropriate.

### X-Ray Tube Device

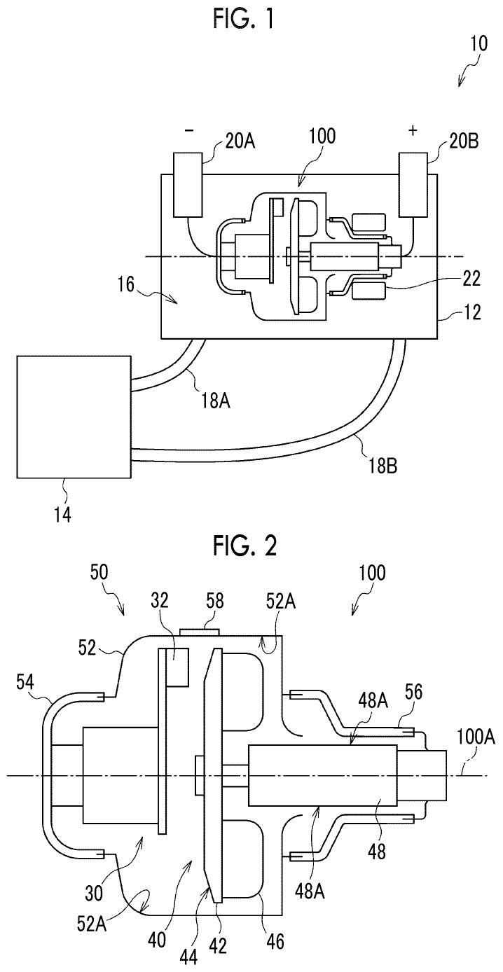

FIG. 1 is a schematic configuration diagram of an X-ray tube device 10 according to the embodiment. The X-ray tube device 10 includes an X-ray tube container 12, a cooler 14, and an X-ray tube 100.

The X-ray tube container 12 is a case made of an aluminum plate that accommodates the X-ray tube 100, and is lined with a lead plate for X-ray protection. The X-ray tube container 12 accommodates the X-ray tube 100 together with cooling oil 16 that is insulating oil. The X-ray tube 100 is immersed in the cooling oil 16 accommodated in the X-ray tube container 12 and is insulated from the X-ray tube container 12.

The X-ray tube container 12 and the cooler 14 are connected to each other through a first pipe line 18A and a second pipe line 18B. The cooler 14 includes a fan (not shown) and a radiator (not shown), and the fan and the radiator cool the cooling oil 16 inside the cooler 14. The X-ray tube device 10 includes a supply pump (not shown) that supplies the insulating oil inside the cooler 14 to the inside of the X-ray tube container 12, and a recovery pump (not shown) that supplies the insulating oil inside the X-ray tube container 12 to the inside of the cooler 14.

The cooling oil 16 cooled by the cooler 14 circulates through the cooler 14, the first pipe line 18A, the X-ray tube container 12, the second pipe line 18B, and the cooler 14 in this order by the supply pump and the recovery pump. As a result, the cooler 14 can cool the X-ray tube 100.

The X-ray tube container 12 is provided with a connector 20A that is electrically connected to a cathode 30 (see FIG. 2) of the X-ray tube 100, and a connector 20B that is electrically connected to a rotating anode 40 (see FIG. 2). A high-voltage generation device (not shown) for applying a high voltage between the cathode 30 and the rotating anode 40 is connected to the connectors 20A and 20B.

A drive coil 22 that receives power supply from a drive unit (not shown) and generates a rotational force on a rotor 48 (see FIG. 2) is disposed on an anode side of the X-ray tube 100.

FIG. 2 is a schematic configuration diagram of the X-ray tube 100. The X-ray tube 100 includes the cathode 30, the rotating anode 40 that has a rotation mechanism to rotate around a central axis 100A of the X-ray tube 100, and a housing 50 that accommodates and insulatingly supports the cathode 30 and the rotating anode 40 in a vacuum atmosphere.

The cathode 30 includes a filament (not shown) that emits electrons, and a focusing assembly 32 that supports the filament and focuses the electrons.

The rotating anode 40 includes a disk-shaped target 42 and the rotor 48. The target 42 is made of molybdenum. The target 42 includes a target surface 44 that is formed to be inclined to emit X-rays toward an X-ray radiation window 58 described below. The target surface 44 is made of tungsten. In addition, the target 42 includes a heat storage unit 46 on a surface opposite to the target surface 44. The heat storage unit 46 is made of graphite. The rotor 48 rotatably supports a rotation shaft (not shown) and rotatably supports the target 42. The rotor 48 is made of copper, and a thin layer of martensitic stainless steel is provided on a side surface 48A of the rotor 48.

The housing 50 includes a cylindrical metal housing 52 that surrounds the focusing assembly 32 of the cathode 30 and the target 42 of the rotating anode 40, a cathode-side glass housing 54 that insulatingly supports the cathode 30, and an anode-side glass housing 56 that insulatingly supports the rotating anode 40. The glass constituting the cathode-side glass housing 54 and the anode-side glass housing 56 has a radiation rate of about 0.8 [dimensionless]. The metal housing 52 is made of martensitic stainless steel. The metal housing 52 has an opening portion, and an X-ray radiation window 58 made of a heat-resistant metal material having high X-ray transmittance is bonded to the opening portion. In addition, the drive coil 22 (see FIG. 1) is disposed around the anode-side glass housing 56.

In a case where a negative voltage is applied to the filament of the cathode 30 from the high-voltage generation device (not shown), the filament is heated to generate thermoelectrons. In addition, in a case where a positive voltage is applied to the target 42 of the rotating anode 40, the thermoelectrons (electron beams) emitted from the filament and converged by the focusing assembly 32 are accelerated by a potential difference between the filament and the target 42 and collide with the target 42. X-rays are generated by the thermoelectrons colliding with the target 42. Since the target surface 44 of the target 42 is inclined with respect to the central axis 100A of the X-ray tube 100, the generated X-rays are directed in a direction of the X-ray radiation window 58 and are emitted from the X-ray radiation window 58 to the outside of the X-ray tube 100.

In the X-ray tube device 10, the drive coil 22 and the rotor 48 rotate the target 42 of the rotating anode 40. In the X-ray tube device 10, the target 42 is rotated to change a position where the thermoelectrons collide with the target surface 44, and to disperse a thermal load generated by the collision of the thermoelectrons.

The target 42 reaches a high temperature of about 1000° C. due to the heat generated by the collision of the thermoelectrons. The majority of the heat is dissipated to the metal housing 52 by radiation from the surface of the rotating anode 40, and the remaining heat is transmitted to the rotor 48 by heat conduction. The metal housing 52 receives the heat of the target 42 and dissipates the heat to the cooling oil outside the X-ray tube 100. The rotor 48 dissipates the heat transmitted from the target 42 to the anode-side glass housing 56 mainly by radiation.

Therefore, it is important to improve the radiation rates of an inner surface 52A of the metal housing 52 and the side surface 48A of the rotor 48 and to efficiently dissipate heat.

Improvement of Radiation Rate

As a method for improving the radiation rate, a surface treatment and a film formation treatment are known. For example, a black chromium plating treatment, a painting treatment, a titanium dioxide thermal spray treatment, a greening treatment (wet hydrogen treatment) of forming a chromium oxide on a surface by performing a high-temperature treatment on a metal containing chromium as a main component in hydrogen containing water vapor, and a sandblasting treatment (sandblasting processing) of blasting with an abrasive are known.

However, each of these treatments has the following problems. That is, the black chromium plating treatment has a problem of generating waste liquid and burdening the environment. The painting treatment has a problem in that a solvent or the like in a paint is gradually released into a vacuum, and a vacuum degree is reduced. The titanium dioxide thermal spray treatment has a problem of being expensive and costly. The greening treatment is easy, but the improvement of the radiation rate is insufficient. The sandblasting treatment is easy and low in cost, but the improvement of the radiation rate is insufficient.

As described above, the sandblasting treatment and the greening treatment each have an effect of increasing the radiation rate. Therefore, it is considered that the radiation rate can be further increased by combining both. However, in order to maximize the radiation rate by combining both, suitable conditions are required, and as a result of intensive studies, the present inventor has found that it is preferable to perform the sandblasting treatment and the greening treatment to obtain a surface satisfying the following conditions.

### Examples

The sample was subjected to a sandpaper treatment, a sandblasting treatment, and a greening treatment, and the surface roughness Ra, the radiation rate ε, and the surface state of each sample were examined.

### Material

As a material of the sample, unpolished SUS430 (SUS: Steel Use Stainless) made of martensitic stainless steel containing a large amount of chromium was used.

### Sandpaper Treatment

In the sandpaper treatment, the sample surface was polished using sandpapers having grits of #40, #100, #500, #1000, and #2000, respectively.

### Sandblasting Treatment

In the sandblasting treatment, the sample surface was polished using polishing materials having particle sizes of F46, F70, F110, F150, F180, and F220 defined in JIS R6001, respectively.

### Greening Treatment

In the greening treatment, the sample was held in a wet hydrogen atmosphere at 1000° C. for 10 minutes.

### Processing Contents of Each Sample

Tests 1 to 5 are samples in which a sandpaper treatment of polishing the surface of the material with a sandpaper was performed. The grits of the sandpapers used for the sandpaper treatment of Tests 1 to 5 are #2000, #1000, #500, #100, and #40, respectively. Tests 6 to 10 are samples in which a greening treatment was further performed on the surfaces of Tests 1 to 5.

Tests 13 to 16 are samples in which a sandblasting treatment of polishing the surface of the material with sandblasting was performed. The particle sizes of the abrasives used for the sandblasting treatment of Tests 11 to 16, defined in JIS R6001, are F220, F180, F150, F100, F60, and F46, respectively. Tests 17 to 22 are samples in which a greening treatment was further performed on the surfaces of Tests 11 to 16.

Test 23 is a sample of solid material. Test 23 is a glossy plate, and the sandpaper treatment and the sandblasting treatment were not performed. Test 24 is a sample in which a greening treatment was performed on the surface of Test 23.

### Measurement

The surface roughness Ra was measured using a surface roughness measuring machine SURFCOM-FLEX-35B manufactured by Tokyo Seimitsu Co., Ltd. the radiation rate ε was measured using a radiation thermometer IT-340 manufactured by Horiba, Ltd. In a case of measuring the radiation rate ε, the black body tape and each sample of Tests 1 to 24 were placed on a hot plate, the temperature of the black body tape (ε=0.95) was measured, the temperature of the sample was measured next, and the radiation rate ε was adjusted according to the temperature of the black body tape.

### Result

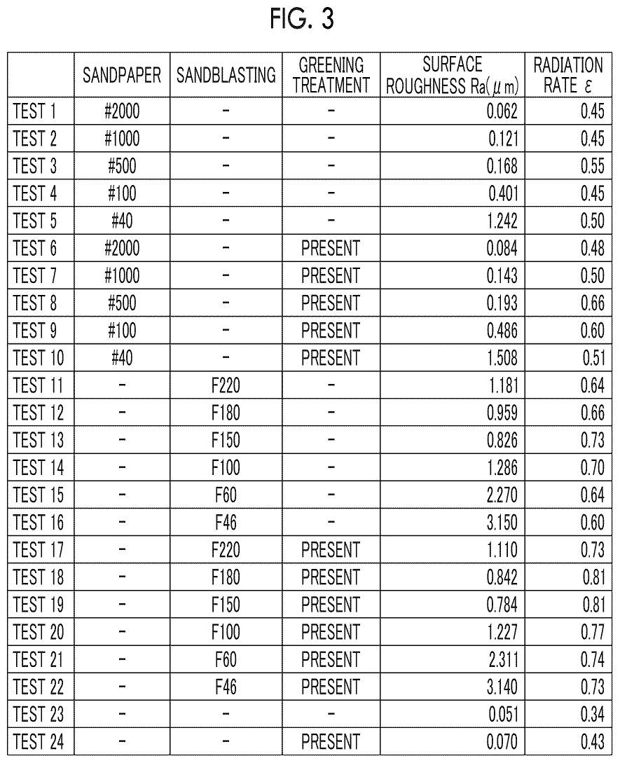

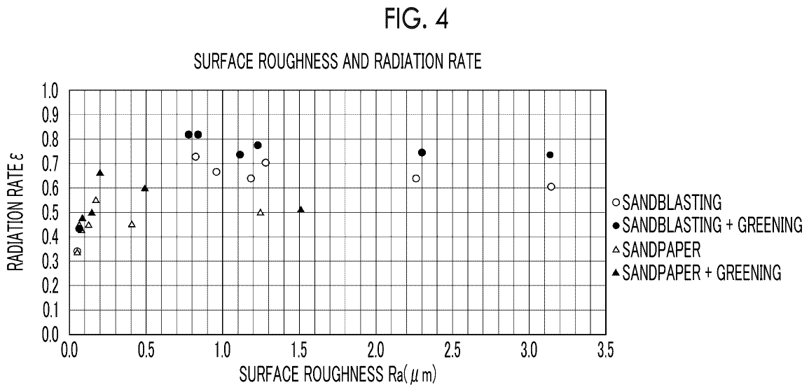

FIG. 3 is a table showing processing conditions of Tests 1 to 24, measurement results of the surface roughness Ra [μm], and measurement results of the radiation rate ε [dimensionless]. In addition, FIG. 4 is a graph in which measurement results of Tests 1 to 22 are plotted with the surface roughness Ra [μm] as an abscissa and the radiation rate ε [dimensionless] as an ordinate. As shown in FIGS. 3 and 4, the following results were obtained.
Since the sandpaper treatment is performed manually, the surface roughness Ra is likely to vary.
Even with the same surface roughness, the radiation rate ε of the surface subjected to the sandblasting treatment is higher than that of the surface subjected to the sandpaper treatment.
the radiation rate ε is further improved by performing the greening treatment on the surface roughened by the sandblasting treatment or the sandpaper treatment.
Among the samples of Tests 1 to 10 in which the sandpaper treatment was performed, the sample of Test 8 had the highest radiation rate ε, which was 0.66 [dimensionless].
Among the samples of Tests 11 to 22 in which the sandblasting treatment was performed, the samples of Tests 18 and 19 had the highest radiation rate ε, which was 0.81 [dimensionless], respectively.
The samples of Tests 18 and 19 had the radiation rate ε exceeding 0.8 [dimensionless], and the surface roughness Ra was 0.842 [μm] and 0.784 [μm], respectively. Tests 18 and 19 are samples in which the greening treatment was performed after the sandblasting treatment using polishing materials having particle sizes of F180 and F150 defined in JIS R6001, respectively.
Since it is presumed that the radiation rates ε of Tests 18 and 19 are near the maximum value of the radiation rate ε and the radiation rate ε also decreases with a decrease in the surface roughness Ra, it is presumed that the lower limit value of the surface roughness Ra obtained by the sandblasting treatment and the greening treatment is 0.70 to 0.75 [μm].
From the change in the radiation rate ε of Tests 17 and 18, it is presumed that the surface roughness Ra obtained by the sandblasting treatment and the greening treatment has a critical point near 0.90 to 1.00 [μm]. Therefore, the upper limit value of the surface roughness Ra is 0.90 to 1.00 [μm].

As described above, the condition in which the radiation rate is maximized is preferably that the surface roughness Ra obtained by the sandblasting treatment and the greening treatment is 0.70 μm or more and 1.00 μm or less, more preferably 0.75 μm or more and 0.90 μm or less, and still more preferably 0.78 μm or more and 0.85 μm or less. By satisfying the above conditions, a high radiation rate as high as graphite, which is about 0.8 [dimensionless], can be obtained.

The surface roughness Ra obtained by the sandblasting treatment and the greening treatment being within the above-described range can be confirmed by surface observation and measurement using a surface roughness measuring machine. That is, in the surface observation, it is possible to check whether or not the sandblasting treatment is performed and whether or not the greening treatment is performed, and in the measurement using the surface roughness measuring machine, it is possible to measure the value of the surface roughness Ra. In addition, it may be confirmed that the radiation rate ε is 0.80 or more by measuring the radiation rate ε using a non-contact thermometer.

### State of Surface

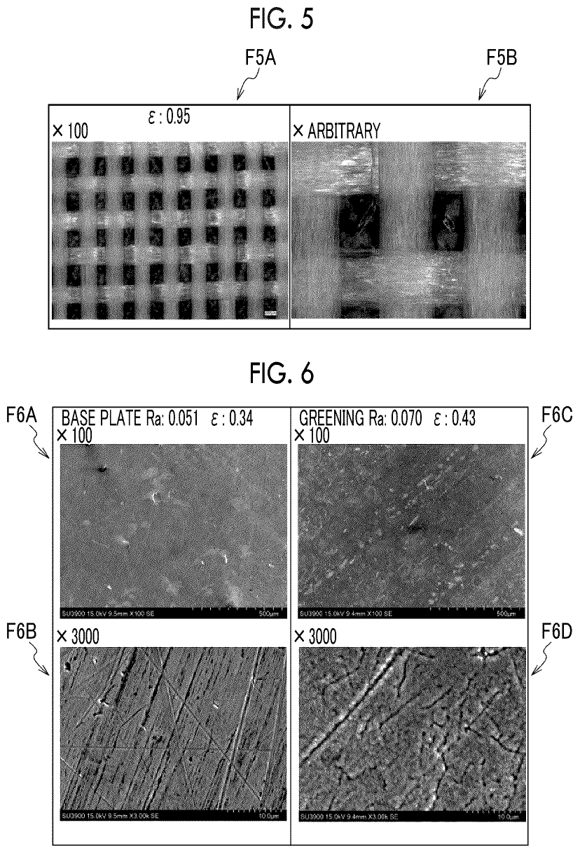

FIG. 5 is a photograph of a surface of a black body tape. F5A of FIG. 5 is a photograph obtained by imaging the surface at 100 times magnification, and F5B of FIG. 5 is a photograph obtained by imaging the surface at an arbitrary magnification. the radiation rate ε of the black body tape was 0.95. As shown in FIG. 5, the surface of the black body tape is formed with undulations, and fine unevenness and voids by a bundle of fine fibers. It is considered that these undulations, and fine unevenness and voids contribute to the high radiation rate.

FIG. 6 is a photograph of surfaces of Test 23 and Test 24 in which the greening treatment was performed on Test 23. F6A of FIG. 6 is a photograph obtained by imaging the surface of Test 23 at 100 times magnification, and F6B of FIG. 6 is a photograph obtained by imaging the surface of Test 23 at 3000 times magnification. F6C of FIG. 6 is a photograph obtained by imaging the surface of Test 24 at 100 times magnification, and F6D of FIG. 6 is a photograph obtained by imaging the surface of Test 24 at 3000 times magnification. The surface of the solid material of Test 23 is flat, and the surface of Test 24 in which the greening treatment was performed has not changed much as compared with the surface of Test 23.

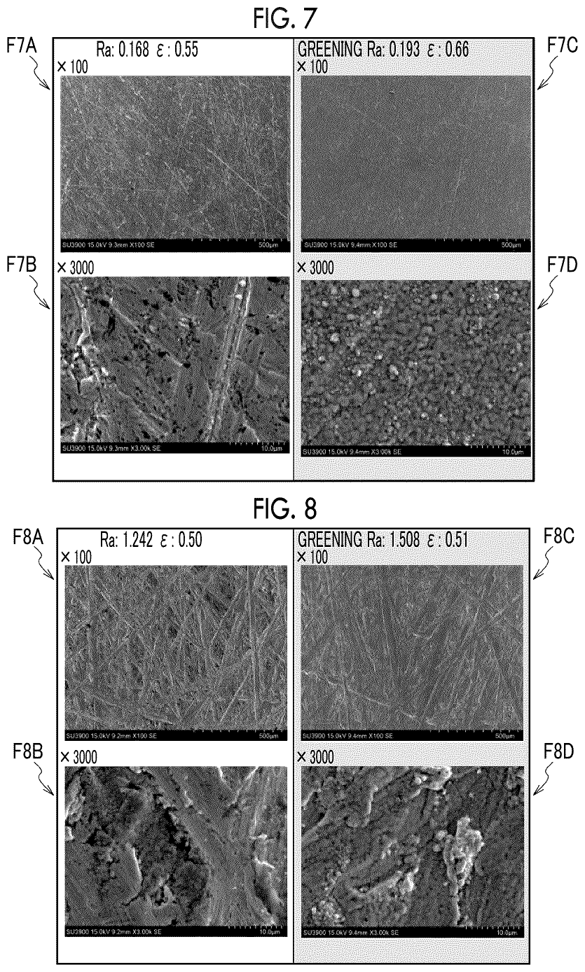

FIG. 7 is a photograph of surfaces of Test 3 in which the sandpaper treatment was performed and Test 8 in which the greening treatment was performed on Test 3. F7A of FIG. 7 is a photograph obtained by imaging the surface of Test 3 at 100 times magnification, and F7B of FIG. 7 is a photograph obtained by imaging the surface of Test 3 at 3000 times magnification. As shown in FIG. 7B, the surface of Test 3 has a larger roughness than the surface of Test 23 of FIG. 6B by the sandpaper treatment. In addition, F7C of FIG. 7 is a photograph obtained by imaging the surface of Test 8 at 100 times magnification, and F7D of FIG. 7 is a photograph obtained by imaging the surface of Test 8 at 3000 times magnification. As shown in F7D, granular substances that are precipitates of chromium oxide are present on the surface of Test 8 by the greening treatment.

FIG. 8 is a photograph of surfaces of Test 5 in which the sandpaper treatment was performed and Test 10 in which the greening treatment was performed on Test 5. F8A of FIG. 8 is a photograph obtained by imaging the surface of Test 5 at 100 times magnification, and F8B of FIG. 8 is a photograph obtained by imaging the surface of Test 5 at 3000 times magnification. As shown in F8B, the surface of Test 5 has a larger roughness than the surface of Test 3 of F7B. In addition, F8C of FIG. 8 is a photograph obtained by imaging the surface of Test 10 at 100 times magnification, and F8D of FIG. 8 is a photograph obtained by imaging the surface of Test 10 at 3000 times magnification. As shown in F8B, granular substances that are precipitates of chromium oxide are observed on the surface of Test 10, but the granular substances are smaller than those on the surface of Test 8 of F7D.

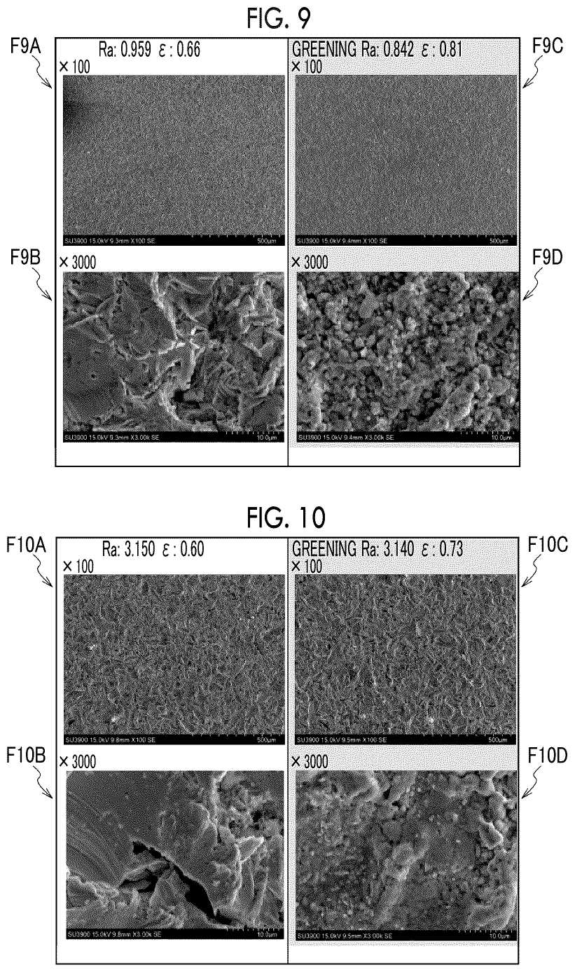

FIG. 9 is a photograph of surfaces of Test 12 in which the sandblasting treatment was performed and Test 18 in which the greening treatment was performed on Test 12. F9A of FIG. 9 is a photograph obtained by imaging the surface of Test 12 at 100 times magnification, and F9B of FIG. 9 is a photograph obtained by imaging the surface of Test 12 at 3000 times magnification. As shown in F9B, the surface of Test 12 has a larger roughness than the surface of Test 23 of F6B by the sandblasting treatment, and has an isotropic roughness as compared with the surface of Test 3 of F7B. In addition, F9C of FIG. 9 is a photograph obtained by imaging the surface of Test 18 at 100 times magnification, and F9D of FIG. 9 is a photograph obtained by imaging the surface of Test 18 at 3000 times magnification. As shown in F9D, a large number of granular substances that are precipitates of chromium oxide are present on the surface of Test 18 as compared with the surface of Test 8 of F7D.

FIG. 10 is a photograph of surfaces of Test 16 in which the sandblasting treatment was performed and Test 22 in which the greening treatment was performed on Test 16. F10A of FIG. 10 is a photograph obtained by imaging the surface of Test 16 at 100 times magnification, and F10B of FIG. 10 is a photograph obtained by imaging the surface of Test 16 at 3000 times magnification. As shown in F10B, the surface of Test 16 has a larger roughness than the surface of Test 12 of F9B. In addition, F10C of FIG. 10 is a photograph obtained by imaging the surface of Test 22 at 100 times magnification, and F10D of FIG. 10 is a photograph obtained by imaging the surface of Test 22 at 3000 times magnification. As shown in F10D, granular substances that are precipitates of chromium oxide are observed on the surface of Test 22, but the granular substances are smaller than those on the surface of Test 18 of F9D.

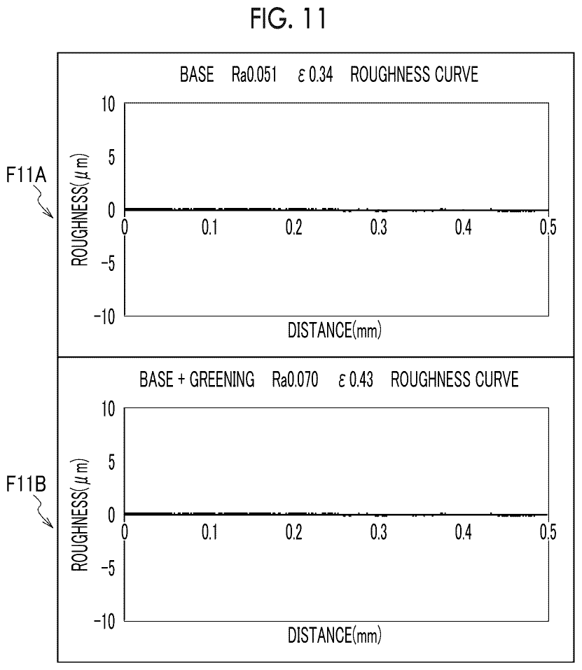

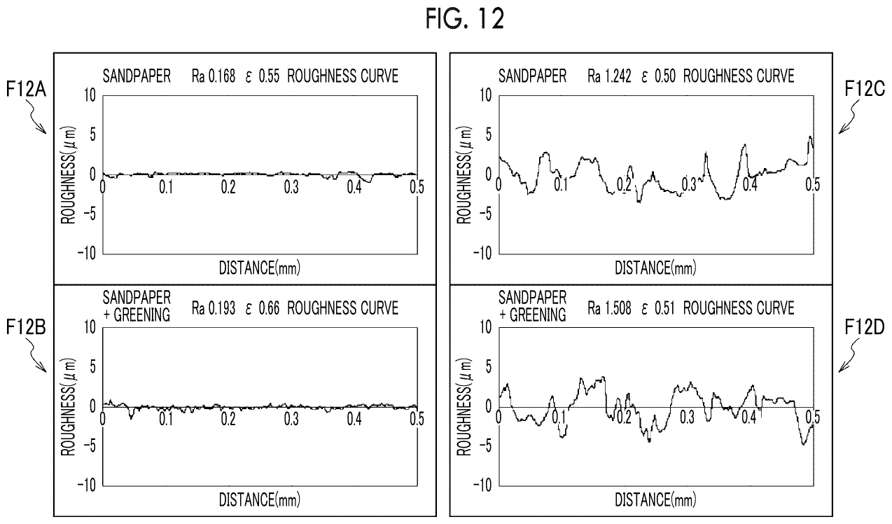

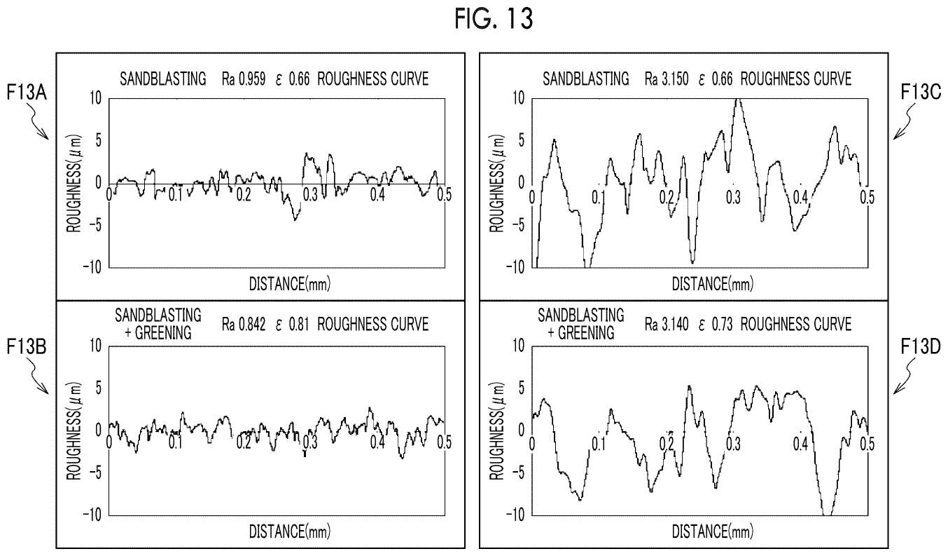

FIGS. 11 to 13 are roughness curves of the surfaces of each sample, in which the abscissa represents a distance [mm] from a reference position, and the ordinate represents a roughness [μm] which is a height of the surface with respect to an average plane. F11A of FIG. 11 is a roughness curve of the surface of Test 23, and F11B of FIG. 11 is a roughness curve of the surface of Test 24. F12A of FIG. 12 is a roughness curve of the surface of Test 3, F12B of FIG. 12 is a roughness curve of the surface of Test 8, F12C of FIG. 12 is a roughness curve of the surface of Test 5, and F12D of FIG. 12 is a roughness curve of the surface of Test 10. F13A of FIG. 13 is a roughness curve of the surface of Test 12, F13B of FIG. 13 is a roughness curve of the surface of Test 18, F13C of FIG. 13 is a roughness curve of the surface of Test 16, and F13D of FIG. 13 is a roughness curve of the surface of Test 22.

In the observation of the photograph of the surface after the greening treatment, the undulations, and the fine unevenness and voids due to the granular substances can be confirmed, but as shown in FIGS. 11 to 13, the voids cannot be detected by the roughness measuring machine. Therefore, the condition in which the radiation rate of the example is maximized is not only that the surface roughness Ra is 0.70 μm or more and 1.00 μm or less, but also that the surface is the surface obtained by the sandblasting treatment and the greening treatment.

### Factors for Improving Radiation Rate

### Effect of Greening Treatment

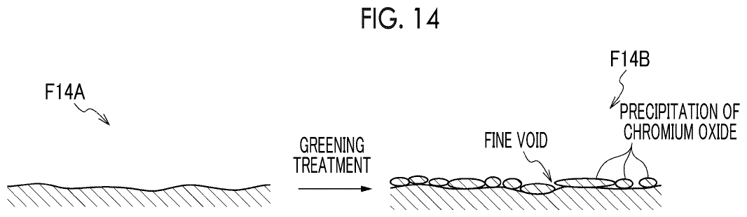

FIG. 14 is a diagram for describing an effect of the greening treatment. F14A of FIG. 14 schematically shows a cross section of the surface before the greening treatment, and F14B of FIG. 14 schematically shows a cross section of the surface after the greening treatment. In a case where the greening treatment is performed, the chromium oxide is precipitated. The chromium oxide forms undulations and complex unevenness on the surface, and the radiation rate ε is increased. This is the same principle as the black body tape having a high radiation rate ε. In addition, as shown in F14A, by roughening the surface in advance, fine voids are formed as shown in F14B, and the surface shape is further complicated. That is, the granular substances are collected and distributed to form voids that open between the granular substances, and the surface area is increased. As a result, the radiation rate is improved.

### Comparison Between Sandpaper Treatment and Sandblasting Treatment

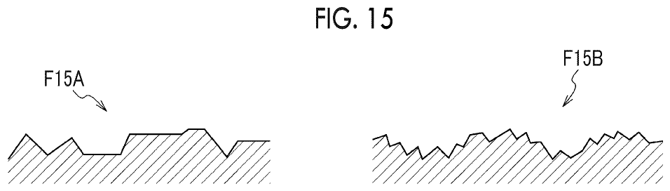

FIG. 15 is a diagram for describing a comparison between the sandpaper treatment and the sandblasting treatment. F15A of FIG. 15 schematically shows a cross section of the surface after the sandpaper treatment, and F15B of FIG. 15 schematically shows a cross section of the surface after the sandblasting treatment. Since the surface is polished in a linear shape in the sandpaper treatment, a glossy surface tends to remain partially. On the other hand, since more complicated unevenness is generated on the average surface in the sandblasting treatment than in the sandpaper treatment, the radiation rate is also relatively large.

### Optimal Value of Surface Roughness Ra

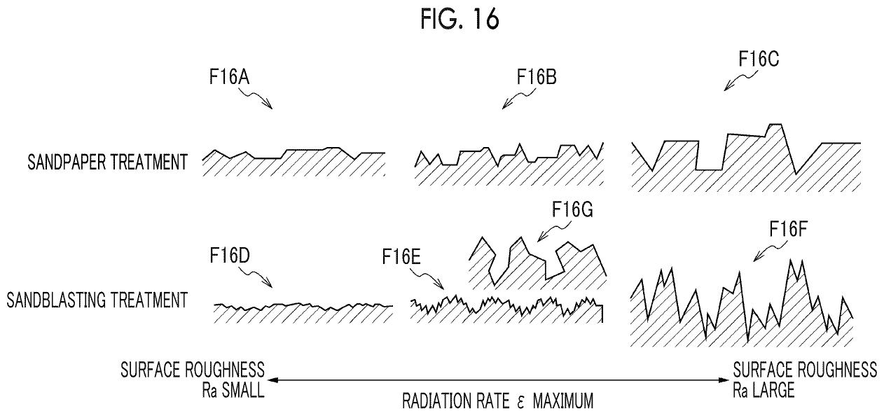

FIG. 16 is a diagram for describing an optimal value of the surface roughness Ra. F16A, F16B, and F16C of FIG. 16 schematically show cross sections of the surfaces after the sandpaper treatment, in which F16A shows a surface having a relatively small surface roughness Ra, F16C shows a surface having a relatively large surface roughness Ra, and F16B shows a surface having a surface roughness Ra at which the radiation rate ε is maximized. In addition, F16D, F16E, and F16F of FIG. 16 schematically show cross sections of the surfaces after the sandblasting treatment, in which F16D shows a surface having a relatively small surface roughness Ra, F16F shows a surface having a relatively large surface roughness Ra, and F16E shows a surface having a surface roughness Ra at which the radiation rate ε is maximized. F16G of FIG. 16 shows a surface obtained by enlarging a part of F16E.

As shown in FIG. 16, in both the sandpaper treatment and the sandblasting treatment, the radiation rate is not necessarily higher as the grit of the sandpaper or the particle size of the abrasive of the sandblasting treatment are finer or coarser. Both the sandpaper treatment and the sandblasting treatment have a peak value in the radiation rate, and there is an appropriate roughness at which the radiation rate is maximized. That is, there is an appropriate roughness for forming the undulations, unevenness, and voids on the entire surface.

### SUMMARY

It is important to improve the radiation rates of the inner surface 52A of the metal housing 52 of the X-ray tube 100 and the side surface 48A of the rotor 48 in the X-ray tube device 10. On the other hand, the radiation rates of the side surface 48A of the rotor 48 and the inner surface 52A of the metal housing 52 can be improved by a surface treatment method including a sandblasting treatment step of performing a sandblasting treatment on the side surface 48A of the rotor 48 and the inner surface 52A of the metal housing 52, and a greening treatment step of performing a greening treatment on the surface after the sandblasting treatment, in which a surface roughness Ra of the surface after the greening treatment is 0.70 μm or more and 1.00 μm or less. The surface roughness Ra of the surface after the greening treatment step is more preferably 0.75 μm or more and 0.90 μm or less, and still more preferably 0.78 μm or more and 0.85 μm or less.

The sandblasting treatment includes blasting with an abrasive having a particle size of F150 or F180 defined in JIS R6001. The greening treatment includes holding the surface in a wet hydrogen atmosphere at 1000° C. or higher for 10 minutes or longer.

A manufacturing method of a stainless steel component in which a radiation rate is improved includes a sandblasting treatment step of performing a sandblasting treatment on a surface of the stainless steel component, and a greening treatment step of performing a greening treatment on the surface after the sandblasting treatment, in which a surface roughness Ra of the surface after the greening treatment is 0.70 μm or more and 1.00 μm or less. The surface roughness Ra of the surface after the greening treatment step is more preferably 0.75 μm or more and 0.90 μm or less, and still more preferably 0.78 μm or more and 0.85 μm or less.

The stainless steel may be martensitic stainless steel. The stainless steel component is not limited to a component in which the entire component is made of stainless steel, and may include a component in which a layer of stainless steel is provided on at least a part of a surface of a component other than stainless steel. The stainless steel component may be the rotor 48 that rotatably supports the target 42 of the rotating anode 40. The surface of the stainless steel component may be the side surface 48A of the rotor 48. The stainless steel component may be the metal housing 52 of the housing 50 of the X-ray tube. The surface of the stainless steel component may be the inner surface 52A of the metal housing 52.

A manufacturing method of an X-ray tube including a cathode 30, a rotating anode 40, and a housing 50 that accommodates and insulatingly supports the cathode 30 and the rotating anode 40 in a vacuum-tight manner includes a sandblasting treatment step of performing a sandblasting treatment on a surface of stainless steel on at least a part of a side surface of the rotor 48 included in the rotating anode 40 and an inner surface of the metal housing 52 included in the housing 50, and a greening treatment step of performing a greening treatment on the surface after the sandblasting treatment, in which a surface roughness Ra of the surface after the greening treatment step is 0.70 μm or more and 1.00 μm or less. The surface roughness Ra of the surface after the greening treatment step is more preferably 0.75 μm or more and 0.90 μm or less, and still more preferably 0.78 μm or more and 0.85 μm or less.

The technical scope of the present disclosure is not limited to the scope according to the embodiment described above. The configurations and the like in each embodiment can be appropriately combined between the respective embodiments without departing from the gist of the present disclosure.

What is claimed is:

1. A surface treatment method comprising:
a sandblasting treatment step of performing a sandblasting treatment on a surface of stainless steel; and
a greening treatment step of performing a greening treatment on the surface after the sandblasting treatment step,
wherein a surface roughness Ra of the surface after the greening treatment step is 0.70 μm or more and 1.00 μm or less.

2. The surface treatment method according to claim 1,
wherein a surface roughness Ra of the surface after the greening treatment step is 0.75 μm or more and 0.90 μm or less.

3. The surface treatment method according to claim 1,
wherein a surface roughness Ra of the surface after the greening treatment step is 0.78 μm or more and 0.85 μm or less.

4. The surface treatment method according to claim 1,
wherein the sandblasting treatment includes blasting with an abrasive having a particle size of F150 or F180 defined in JIS R6001.

5. The surface treatment method according to claim 1,
wherein the greening treatment includes holding the surface in a wet hydrogen atmosphere at 1000° C. or higher for 10 minutes or longer.

6. The surface treatment method according to claim 1,
wherein the stainless steel is martensitic stainless steel.

7. A stainless steel component in which a greening treatment is performed on a surface after a sandblasting treatment,
wherein a surface roughness Ra of the surface after the greening treatment is 0.70 μm or more and 1.00 μm or less.

8. An X-ray tube comprising:
a cathode that generates an electron beam;
an anode that emits X-rays by collision of the electron beam;
a housing that insulatingly supports the cathode and the anode in a vacuum atmosphere;
a rotor that supports the anode; and
the stainless steel component according to claim 7.

9. An X-ray tube device comprising:
the X-ray tube according to claim 8; and
a container that accommodates the X-ray tube together with insulating oil.

10. A manufacturing method of a stainless steel component comprising:
a sandblasting treatment step of performing a sandblasting treatment on a surface of the stainless steel component; and
a greening treatment step of performing a greening treatment on the surface after the sandblasting treatment step,
wherein a surface roughness Ra of the surface after the greening treatment step is 0.70 μm or more and 1.00 μm or less.

11. A manufacturing method of an X-ray tube including a cathode that generates an electron beam, an anode that emits X-rays by collision of the electron beam, a housing that insulatingly supports the cathode and the anode in a vacuum atmosphere, and a rotor that supports the anode, the manufacturing method comprising
a step of forming a surface of a part of at least one of the rotor or the housing by using the manufacturing method of a stainless steel component according to claim 10.
